(19) United States
(12) Patent Application Publication
(10) Pub. No.: US 2016/0043910 A1
(43) Pub. Date: Feb. 11, 2016

(54) System and Method for Obtaining Deterministic Performance in Virtual Desktop System

(71) Applicant: Dell Products, LP, Round Rock, TX (US)

(72) Inventors: Farzad Khosrowpour, Pflugerville, TX (US); Thomas B. Varble, Round Rock, TX (US)

(21) Appl. No.: 14/452,132

(22) Filed: Aug. 5, 2014

(51) Int. Cl. H04L 12/24; G06F 9/455; H04L 12/26

(52) U.S. Cl. CPC H04L 41/5009; H04L 43/08; G06F 9/45558; G06F 2009/45595

(57) ABSTRACT

A virtual desktop system includes a user system, a system manager, and a virtualization host including a processor and a performance module. The performance module is operable to receive a first data packet, determine that the first data packet is associated with the user system, and add a label to the first data packet, the label being operable to provide performance information for the virtual desktop system. The user system is operable to receive the first data packet and extract the performance information from the label. The system manager is operable to receive the performance information from the user system.

### FIELD OF THE DISCLOSURE

This disclosure relates generally to information handling systems, and more particularly relates to obtaining deterministic performance in a virtual desktop system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems. A virtual desktop infrastructure separates a desktop environment and its associated software in a data center, from the information handling system that is used to access the desktop environment.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a virtual desktop environment according to an embodiment of the present disclosure;

FIG. 2 is a block diagram of another virtual desktop environment according to an embodiment of the present disclosure;

FIGS. 3-5 are block diagrams of virtualization hosts according to various embodiments of the present disclosure; and

FIG. 6 is a block diagram illustrating a generalized information handling system according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

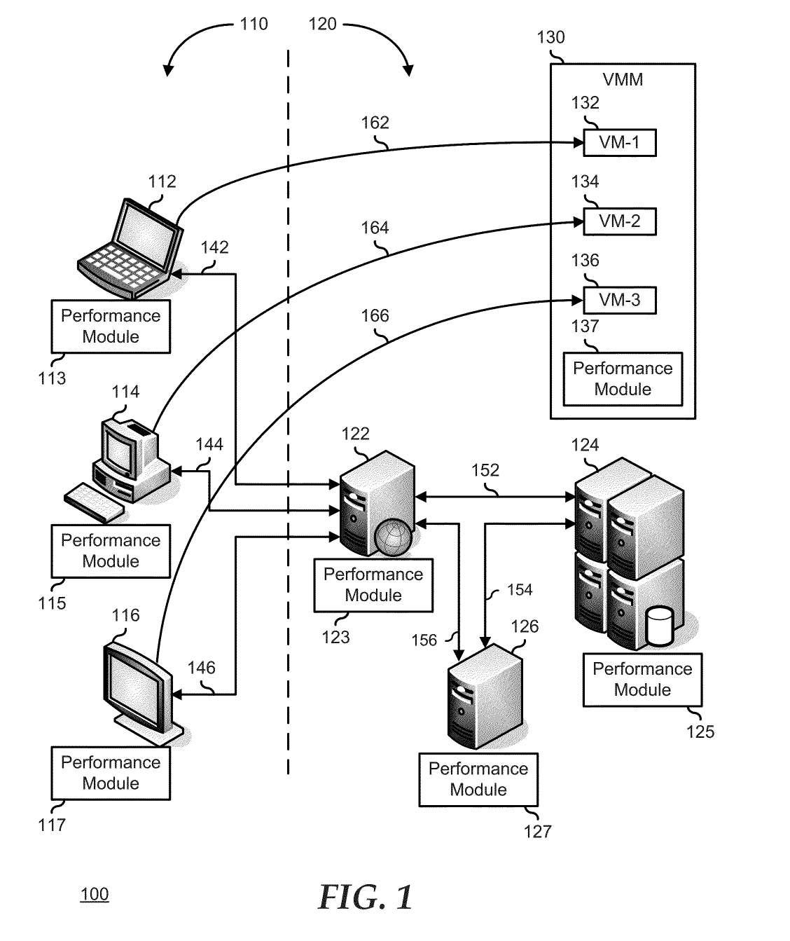

FIG. 1 illustrates a virtual desktop environment 100 that can be implemented on one or more information handling system. For purposes of this disclosure, an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a laptop computer, a smart phone, a tablet device or other consumer electronic device, a network server, a network storage device, a switch, a router, or another network communication device, or any other suitable device and may vary in size, shape, performance, functionality, and price. Further, an information handling system can include processing resources for executing machine-executable code, such as a central processing unit (CPU), a programmable logic army (PIA), an embedded device such as a System-on-a-Chip (SoC), or other control logic hardware. An information handling system can also include one or more computer-readable medium for storing machine-executable code, such as software or data. Additional components of an information handling system can include one or more storage devices that can store machine-executble code, one or more communications ports for communicating with external devices, and various input and output (I/O) devices, such as a keyboard, a mouse, and a video display. An example of an information handling system includes a multi-tenant chassis system where groups of tenants (users) share a common chassis, and each of the tenants has a unique set of resources assigned to them. The resources can include blade servers of the chassis, input/output (I/O) modules, Peripheral Component Interconnect-Express (PCIe) cards, storage controllers, and the like.

Virtual desktop environment 100 includes a user environment 110 and a virtual desktop infrastructure (VDI) 120. User environment 110 includes user systems 112, 114, and 116. VDI 120 includes a virtual desktop manager 122, a virtualization host 124, and a VDI manager 126. Virtual desktop environment 100 operates to present a remotely operated and maintained operating system environment and application software to users 112, 114, and 116. In particular, when one of users 112, 114, and 116 logs on to VDI 120, virtual desktop manager 122 authenticates the user, determines the operating system environment and application software needs of the user, and directs virtualization host 124 to instantiate a virtual machine that is associated with the user, and that runs the operating system environment and application software. Virtualization host 124 includes a virtual machine manager (VMM) 130 that operates to manage the virtual machines. Thus when user 112 logs on to VDI 120, virtual desktop manager 122 directs virtualization host 124 to instantiate a virtual machine 132 associated with the user. Similarly, a virtual machine 134 is instantiated when user 114 logs on to VDI 120, and a virtual machine 136 is instantiated when user 116 logs on.

In a particular embodiment, two or more of virtual machines 132, 134, and 136 are instantiated from a common image, such that each of the virtual machines is utilizing the same operating system environment and application software. In this way, any patches, modifications, or upgrades that are applied to the common image are thereby promulgated to the particular users 112, 114, or 116 that are using the common image. In this way, the cost of maintenance and service for virtual desktop environment 100 is reduced over maintaining separate operating system environments and application software for each of users' 112, 114, and 116 systems. By using the common image, each of users 112, 114, and 116 can operate using the same operating system environment and application software, without regard to what type of system each user operates. In another embodiment, one or more of virtual machines 132, 134, and 136 is instantiated from a different image, such that the virtual machine is utilizing a different operating system environment or application software.

In a particular embodiment, each of users 112, 114, and 116 log on to VDI 120 over a protected network, such as a corporate wide-area network (WAN), local area network (LAN), intranet, or the like, such that the users have secure access to their respective virtual machines 132, 134, and 136. In another embodiment, each of users 112, 114, and 116 log on to VDI 120 over a public network, such as the Internet, a publicly accessible Wi-Fi network, or the like. Here, desktop manager 122 operates to ensure that users 112, 114, and 116 have secure access to their respective virtual machines 132, 134, and 136. For example, desktop manager 122 can operate to provide a virtual private network (VPN) or another secure communication channel to users 112, 114, and 116. In this way, the access to each user to their respective operating system environments and application software is available to the users from remote locations and through a wide array of connected devices. In yet another embodiment, each of users 112, 114, and 116 have the option of using a protected network or a public network.

In a particular embodiment, virtual machines 132, 134, and 136 remain instantiated on virtualization host 124 when the respective users 112, 114, and 116 log off of their virtual desktop. Here, a particular user can be provided with unique access to their own virtual desktop, such that any changes made, such as to personalize the virtual desktop, are maintained after logging off and later logging back on in a later session. However, in this embodiment, virtualization host 124 incurs an overhead by keeping virtual machines 132, 134, and 136 instantiated, even when no user 112, 114, or 116 is logged on. In another embodiment, virtual machines 132, 134, and 136 remain instantiated on virtualization host 124 when the respective users 112, 114, and 116 log off of their virtual desktop. However, here no particular user is associated with a particular virtual desktop, and each time the user togs back on, the virtual desktop is unchanged from the previous session. In this embodiment, virtualization host 124 can keep one or more of virtual machines 132, 134, and 136 instantiated, and then can instantiate additional virtual machines as the number of users increases. For example, in this way a data center can allocate processing resources of virtualization host 124 to running virtual desktops during business hours, and can allocate the processing resources to other tasks during the off hours.

Virtual desktop manager 122 operates to manage the connections between users 112, 114, and 116 and VDI 120, including authentication, user locations, session state, timeouts, and the like. In the embodiment where virtual machines 132, 134, and 136 remain instantiated, virtual desktop manager 122 operates to manage the unused virtual machines, and assign a virtual machine to a user when a new user logs on to VDI 120. In the embodiment where virtual machines 132, 134, and 136 are dynamically instantiated on virtualization host 124, desktop manager 122 operates to determine when to instantiate new virtual machines, or to halt existing virtual machines.

Virtual desktop environment 100 operates to continuously gather information related to the performance of the environment. In particular, virtual desktop environment 100 provides a tagging scheme for data traffic within the environment which allows for traffic mapping, traffic shaping, latency determination, and assurance of quality of service (QoS) levels for all data traffic within the environment. Further, the tagging scheme permits performance analysis on a per-link basis, and end-to-end performance analysis on a per user basis, on a per application basis, and on a per QoS level basis. An example of monitoring per-link performance includes monitoring link traffic in user environment 110 such as links 142, 144, and 146 between respective users 112, 114, and 116, and virtual desktop manager 122, monitoring link traffic in VDI 120, such as links 152, 154, and 156 between the virtual desktop manager, virtualization host 124, and VDI manager 126. An example of monitoring end-to-end performance includes monitoring traffic in virtual links 162, 164, and 166 between respective users 112, 114, and 116, and virtual machines 132, 134, and 136.

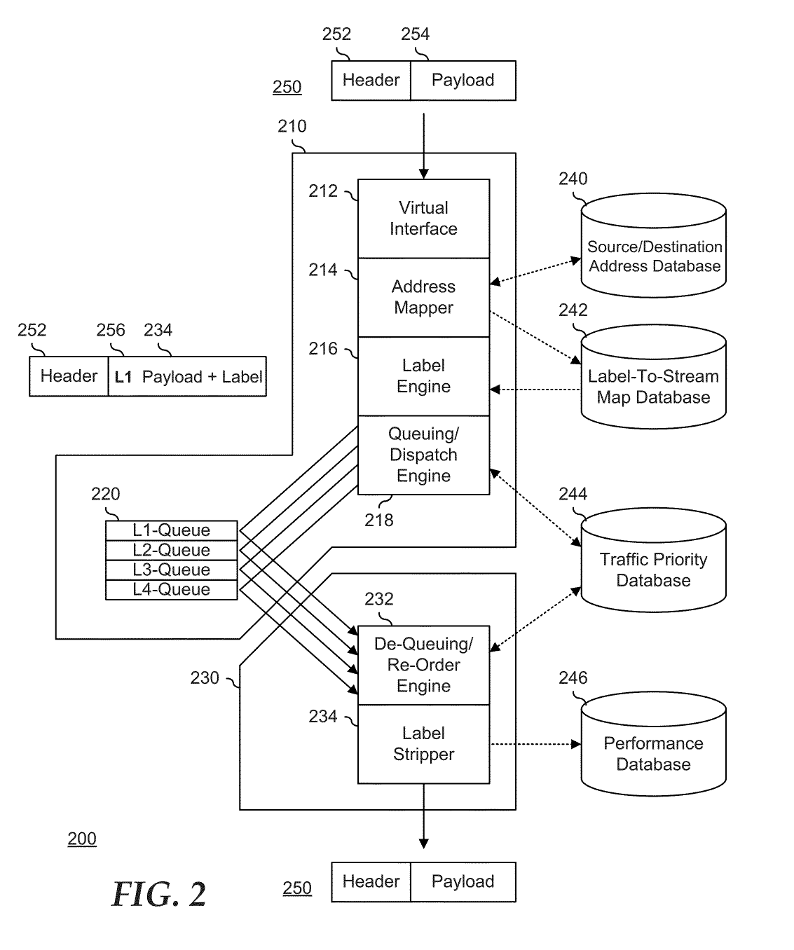

As such, users 112, 114, and 116, virtual desktop manager 122, virtualization host 124, VDI manager 126, and VMM 130 include respective performance modules 113, 115, 117, 123, 125, 127, and 137 for tagging and un-tagging data traffic within virtual desktop environment 100, and for collecting performance data related to the data traffic on links 142, 144, 146, 152, 154, and 156 and on virtual links 162, 164, and 166. An example of a tag added to data traffic within virtual desktop environment 100 includes the addition of a timestamp to data packets for a particular data flow, the addition of resource utilization information to data packets for the data flow, such as a processor or virtual machine utilization level information, storage usage level information, other resource utilization information, I/O bandwidth utilization information, and the like, the addition of other information to data packets for the data flow, or a combination thereof. For example, considering a data flow between user 112 and virtual machine 132, performance module 137 can tag data packets that are associated with virtual link 162. The tag can also indicate that the tag was added at VMM 130. The data packets are then sent internally through virtualization host 124 where performance module 125 can read the tag to determine performance information for within the virtualization host. Also, performance module 12.5 can un-tag the data packets or can provide a second tag to the data packets that indicates that the data packets were also tagged by virtualization host 124. In this way, when the data packets are sent to virtualization manager 122, performance module 123 can read the one or more tags to determine the performance between VMM 130 and the virtualization manager, and to determine the performance over link 152, and can add an additional tag to the data packets. Similarly, when the data packets are sent to user 112, performance module 113 can read the one or more tags to determine the performance between VMM 130 and the user (that is, the end-to-end performance), and to determine the performance over link 142. The tagging scheme will be discussed with respect to FIG. 2, below.

Once the performance data is collected, VDI manager 126 operates to make decisions and take actions within virtual desktop environment 100 based upon the performance data. As such, VDI manager 126 operates to provide performance thresholds for various performance parameters related to links 142, 144, 146, 152, 154, and 156 and virtual links 162, 164, and 166, and to manage the resources within virtual desktop environment 100 when one or more of the performance thresholds is exceeded. For example, considering the data flow between user 112 and virtual machine 132, described above, performance module 113 123, 125, and 137 can provide the performance information gathered from the data flow to VDI manager 126. Here, VDI manager can include one or more thresholds for the data flow, including the end-to-end latency in virtual link 162 and the latencies in any of links 142 and 152. If one or more threshold is exceeded, then VDI manager 126 can rearrange the configuration of virtual desktop environment 100 to ensure that the performance within the environment remains within the various thresholds. For example, VDI manager 126, if the end-to-end latency for virtual link 162 exceeds a threshold, the VDI manager can migrate virtual machine 132 to a more powerful virtualization host, or route the associated data flow through a network of virtual desktop environment 100 via a faster route. The skilled artisan will understand that other actions can be taken in a virtual desktop environment to optimize performance, and that the above examples are not limiting in the scope of actions that can be taken.

In a particular embodiment, virtual desktop environment 100 operates to manage data flows not only on the basis of virtual links 162, 164, and 166, but also on the basis of priority flows within the virtual links. For example, user 114 can provide low priority data traffic over virtual link 164 and also provide high priority data traffic over the virtual link. Here, VDI manager 126 operates to gather the performance information, provide decision thresholds, and take actions based upon the demanded QoS for the various data traffic on each of links 142, 144, 146, 152, 154, and 156, and virtual links 162, 164, and 166. Thus, furthering the above example with user 114, VDI manager 126 may permit the low priority data traffic may experience longer latencies (that is, set a threshold for low priority traffic to a relatively tong setting), but may take more aggressive action to maintain the high priority data traffic within a lower latency threshold. In another example, VDI manger 126 can manage performance based upon other performance information, such as where a particular data flow comprises streaming video or streaming audio data traffic, or where the data traffic is targeted to a particular resource (such as where a graphics intensive application may be directed to a virtualization host that includes a more powerful graphics capability).

FIG. 2 illustrates an embodiment of a virtual desktop environment 200 similar to virtual desktop environment 100 and including performance modules 210 and 220, similar to performance modules 113, 115, 117, 123,125, 127, and 137. Performance module 210 includes a virtual interface 212, an address mapper 214, a label engine 216, a queuing and dispatch engine 218, and QoS buffers 220. Performance module 230 includes a de-queuing and re-order engine 232, and a label stripper 234. Note that FIG. 2 illustrates a unidirectional data flow, and that data flow tagging and mapping can be performed on data flowing in the opposite direction, provided that performance module 210 includes a de-queuing and re-order engine and a label stripper, and that performance module 230 includes a virtual interface, an address mapper, a label engine, a queuing and dispatch engine, and QoS buffers.

Performance module 210 operates to receive data packets associated with various data flows, such as data packet 250. Data packet 250 represents any one of a number of data packet formats as are known in the art, such as an Ethernet packet, an Asynchronous Transfer Mode packet, a Frame Relay packet, a Fibre Channel packet, or the like, and can represent a data packet that includes a combination of data packet formats, such as a Fibre Channel Over Ethernet (FCoE) data packet, as needed or desired. Data packet 250 includes a packet header 252 and a payload 254.

Virtual interface 212 receives data packet 250 and provided to address mapper 214. Data packet 250 is analyzed by address mapper 214 to determine if the source and destination of the data packet corresponds with known sources and destinations within a source/destination database 240. In a particular embodiment, the source and destination represent information included in header 252, such as a source and destination Internet Protocol (IP) address, a source and destination Media Access Control (MAC) address, or another source and destination address that is included in a data packet header. In another embodiment, the source and destination represent information included in payload 254, such as tuples of the payload that represent a particular application or user associated with the data packet. In either embodiment, when address mapper 214 determines that the source and destination of data packet 250 represents a known source and destination, the address mapper provides the data packet to label engine 216 and a label-to-stream database 242 provides an associated label to the label engine. When address mapper 214 determines that the source and destination of data packet 250 represents an unknown source and destination, the source and destination to a label-to-stream map database 242 determines a new label for the source and destination, and provides the new label to label engine 216.

Label engine 216 operates to append a label 256 to payload 254. In a particular embodiment, label 256 is appended in accordance with a, Multi Protocol Label Switching (MPLS) standard, wherein the label is added at the beginning of payload 254. Here, label 256 includes a timestamp and other performance information, as described above, such that a VDI manager similar to VDI manager 126 can collect and process the performance data. Data packet 250 with the appended label 256 is provided to queuing and dispatch engine 218 which determines a priority for the data packet based upon a traffic priority database 244 and places the data packet into an associated priority queue of QoS buffers 220 for transmission to performance module 230. De-queuing and re-order engine 232 determines the priority for data packet 230 from traffic priority database 244 and provides the data packet to label stripper 234. Label stripper 234 retrieves the performance information from label 256 and provides the information to a performance database 246 for processing as described above. Finally, label stripper 234 removes label 256 from data packet 250.

In a particular embodiment, databases 240, 242, 244, and 246 reside in a dedicated device of virtual desktop environment 200, such as in a VDI manager similar to VDI manager 126. In another embodiment, databases 240, 242, 244, and 246 reside in one or more of performance modules 210 and 220. Also, databases 240, 242, 244, and 246 can reside in a combination of a VDI manager and performance modules 210 and 220, or can be otherwise distributed within virtual desktop environment 200.

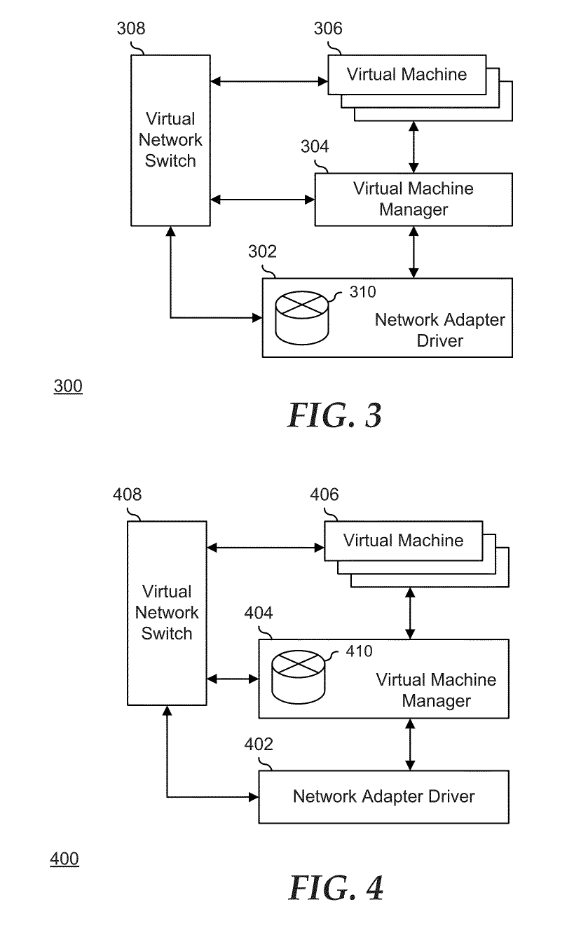

FIGS. 3-5 illustrate various embodiments of a virtualization host, with reference to various locations where a performance monitor similar to performance monitor 125 can he located in the virtualization host. The skilled artisan will recognize that the embodiments shown in FIGS. 3-5 are exemplary and that the skilled artisan would understand that performance monitors could be designed into the other elements of a virtual desktop environment in a variety of locations and ways, as needed or desired.

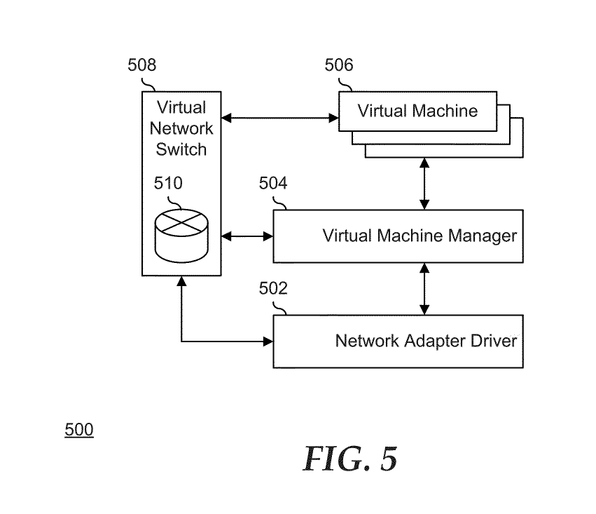

FIG. 3 illustrates a virtualization host 300 including a network adapter driver 302, a VMM 304, one or more virtual machines 306, and a virtual network switch 308. Here, network adapter driver 302 includes a performance monitor 310. FIG. 4 illustrates a virtualization host 400 including a network adapter driver 402, a VMM 404, one or more virtual machines 406, and a virtual network switch 408. Here, VMM 404 includes a performance monitor 410. FIG. 5 illustrates a virtualization host 500 including a network adapter driver 502, a VMM 504, one or more virtual machines 506, and a virtual network switch 508. Here, virtual network switch 508 includes a performance monitor 510.

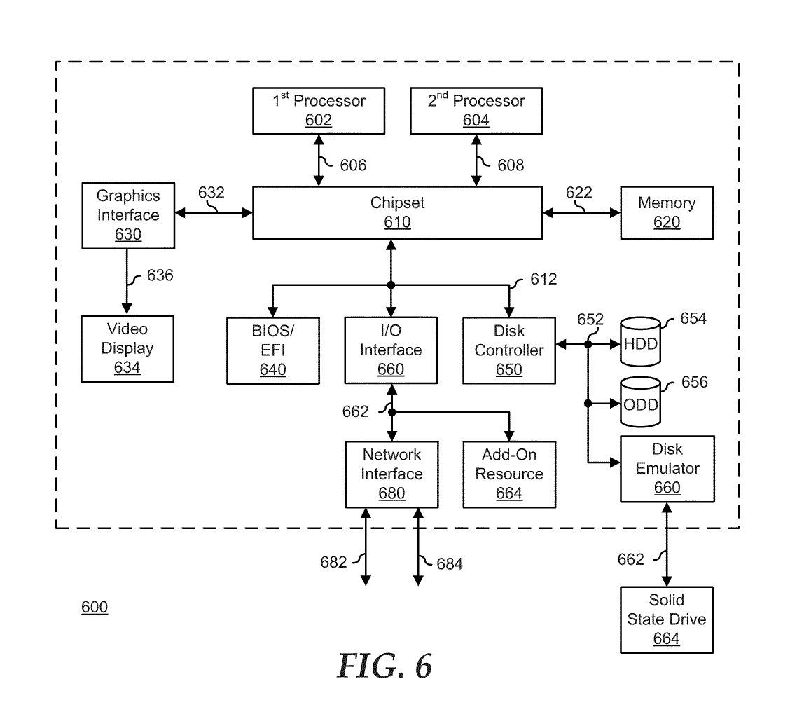

FIG. 6 illustrates a generalized embodiment of information handling system 600. For purpose of this disclosure information handling system 600 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 600 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 600 can include processing resources for executing machine-executable code, such as a central processing unit (CPU), a programmable logic array (PLA), an embedded device such as a System-on-a-Chip (SoC), or other control logic hardware. Information handling system 600 can also include one or more computer-readable medium for storing machine-executable code, such as software or data. Additional components of information handling system 600 can include one or more storage devices that can store machine-executable code, one or more communications ports for communicating with external devices, and various input and output (I/O) devices, such as a keyboard, a mouse, and a video display. Information handling system 600 can also include one or more buses operable to transmit information between the various hardware components.

Information handling system 600 can include devices or modules that embody one or more of the devices or modules described above, and operates to perform one or more of the methods described above. Information handling system 600 includes a processors 602 and 604, a chipset 610, a memory 620, a graphics interface 630, include a basic input and output system/extensible firmware interface (BIOS/EFI) module 640, a disk controller 650, a disk emulator 660, an input/output (I/O) interface 670, and a network interface 680. Processor 602 is connected to chipset 610 via processor interface 606, and processor 604 is connected to the chipset via processor interface 608. Memory 620 is connected to chipset 610 via a memory bus 622. Graphics interface 630 is connected to chipset 610 via a graphics interface 632, and provides a video display output 636 to a video display 634. In a particular embodiment, information handling system 600 includes separate memories that are dedicated to each of processors 602 and 604 via separate memory interfaces. An example of memory 620 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 640, disk controller 650, and I/O interface 670 are connected to chipset 610 via an I/O channel 612. An example of I/O channel 612 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 610 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 640 includes BIOS/EFI code operable to detect resources within information handling system 600, to provide drivers for the resources, initialize the resources, and access the resources. BIOS/EFI module 640 includes code that operates to detect resources within information handling system 600, to provide drivers for the resources, to initialize the resources, and to access the resources.

Disk controller 650 includes a disk interface 652 that connects the disc controller to a hard disk drive (HDD) 654, to an optical disk drive (ODD) 656, and to disk emulator 660. An example of disk interface 652 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 660 permits a solid-state drive 664 to be connected to information handling system 600 via an external interface 662. An example of external interface 662 includes a USB interface, an IEEE 1394 (Firewire) interface, a proprietary interface, or a combination thereof. Alternatively, solid-state drive 664 can be disposed within information handling system 600.

I/O interface 670 includes a peripheral interface 672 that connects the I/O interface to an add-on resource 674 and to network interface 680. Peripheral interface 672 can be the same type of interface as I/O channel 612, or can be a different type of interface. As such, I/O interface 670 extends the capacity of I/O channel 612 when peripheral interface 672 and the I/O channel are of the same type, and the I/O interface translates information from a format suitable to the I/O channel to a format suitable to the peripheral channel 672 when they are of a different type. Add-on resource 674 can include a data storage system, an additional graphics interface, a network interface card (NIC), a sound/video processing card, another add-on resource, or a combination thereof. Add-on resource 674 can be on a main circuit board, on separate circuit board or add-in card disposed within information handling system 600, a device that is external to the information handling system, or a combination thereof.

Network interface 680 represents a NIC disposed within information handling system 600, on a main circuit board of the information handling system, integrated onto another component such as chipset 610, in another suitable location, or a combination thereof Network interface device 680 includes network channels 682 and 684 that provide interfaces to devices that are external to information handling system 600. In a particular embodiment, network channels 682 and 684 are of a different type than peripheral channel 672 and network interface 680 translates information from a format suitable to the peripheral channel to a format suitable to external devices. An example of network channels 682 and 684 includes InfiniBand channels, Fibre Channel channels, Gigabit Ethernet channels, proprietary channel architectures, or a combination thereof. Network channels 682 and 684 can be connected to external network resources (not illustrated). The network resource can include another information handling system, a data storage system, another network, a grid management system, another suitable resource, or a combination thereof.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A virtual desktop system comprising:
a user system;
a system manager; and
a virtualization host including a processor and a performance module, wherein the performance module is operable to:
receive a first data packet;
determine that the first data packet is associated with the user system; and
add a label to the first data packet, the label being operable to provide performance information for the virtual desktop system;
wherein the user system is operable to:
receive the first data packet; and
extract the performance information from the label;
wherein the system manager is operable to receive the performance information from the user system.

2. The virtual desktop system of claim 1, wherein the system manager is further operable to define a first performance threshold between the virtualization host and the user system.

3. The virtual desktop system of claim 2, wherein the system manager is further operable to migrate a virtual machine associated with the user system when the first performance information exceeds the first performance threshold.

4. The virtual desktop system of claim 1, wherein:
the first label comprises a first quality of service level; and
the performance module is further operable to:
receive a second first data packet;
determine that the second data packet is associated with the user system;
add a second label to the second data packet, the second label being operable to provide second performance information for the virtual desktop system, wherein the second label comprises a second quality of service level;
provide the first data packet to a first queue associated with the first quality of service level; and
provide the second data packet to a second queue associated with the second quality of service level.

5. The virtual desktop system of claim 1, further comprising:
virtualization manager operable to:
receive the first data packet; and
extract the first performance information from the first label;
wherein the system manager is further operable to receive the first performance information from the virtualization manager.

6. The virtual desktop system of claim 5, wherein the system manager is further operable to define a second performance threshold between the virtualization host and the virtualization manager.

7. The virtual desktop system of claim 6, wherein the system manager is further operable to reconfigure the virtual desktop system when the first performance information exceeds the second performance threshold.

8. The virtual desktop system of claim 1, wherein the first label is added to the first packet in accordance with a Multi Protocol Label Switching (MPLS) standard.

9. A method comprising:
receiving, at a virtualization host of a virtual desktop infrastructure, a first data packet;
determining, by the virtualization host, that the first data packet is associated with the user system;
adding, by the virtualization host, a label to the first data packet, the label being operable to provide performance information for the virtual desktop infrastructure;
receiving, by a user system of the virtual desktop environment, the first data packet;
extracting, by the user system, the performance information from the label; and
receiving, by an infrastructure manager of the virtual desktop infrastructure, the performance information from the user system.

10. The method of claim 9, further comprising:
defining, by the infrastructure manager, a first performance threshold between t virtualization host and the user system.

11. The method of claim 10, further comprising:
migrating, by the infrastructure manager, a virtual machine associated with the user system when the first performance information exceeds the first performance threshold.

12. The method of claim 9, wherein:
the first label comprises a first quality of service level;
the method further comprising:
receiving, by the performance module, a second first data packet;
determining, by the performance module, that the second data packet is associated with the user system;
adding, by the performance module, a second label to the second data packet, the second label being operable to provide second performance information for the virtual desktop infrastructure, wherein the second label comprises a second quality of service level;
providing the first data packet to a first queue associated with the first quality of service level; and
providing the second data packet to a second queue associated with the second quality of service level.

13. The method of claim 9, further comprising:
receiving, by virtualization manager, the first data packet;
extracting, by virtualization manager, the first performance information from the first label; and
receiving, by the infrastructure manager, the first performance information from the virtualization manager.

14. The method of claim 13, further comprising:
defining, by the infrastructure manager, a second performance threshold between the virtualization host and the virtualization manager.

15. The method of claim 14, further comprising:
reconfiguring, by the infrastructure manager, the virtual desktop infrastructure when the first performance information exceeds the second performance threshold.

16. A non-transitory computer-readable medium including code for performing a method, the method comprising:
receiving, at a virtualization host of a virtual desktop infrastructure, a first data packet;
determining, by the virtualization host, that the first data packet is associated with a user system; and
adding, by the virtualization host, a label to the first data packet, the label being operable to provide performance information for the virtual desktop infrastructure;
receiving, by a user system of the virtual desktop environment, the first data packet;
extracting, by the user system, the performance information from the label; and
receiving, by an infrastructure manager of the virtual desktop infrastructure, the performance information from the user system.

17. The computer-readable medium of claim 16, the method further comprising:
defining, by the infrastructure manager, a first performance threshold between the virtualization host and the user system.

18. The computer-readable medium of claim 17, the method further comprising;
migrating, by the infrastructure manager, a virtual machine associated with the user system when the first performance information exceeds the first performance threshold.

19. The compute-readable medium of claim 16, wherein:
the first label comprises a first quality of service level;
the method further comprising:
receiving, by the performance module, a second first data packet;
determining, by the performance module, that the second data packet is associated with the user system;
adding, by the performance module, a second label to the second data packet, the second label being operable to provide second performance information for the virtual desktop infrastructure, wherein the second label comprises a second quality of service level;
providing the first data packet to a first queue associated with the first quality of service level; and
providing the second data packet to a second queue associated with the second quality of service level.

20. The computer-readable medium of claim 16, the method further comprising:
receiving, by virtualization manager, the first data packet;
extracting, by virtualization manager, the first performance information from the first label;
receiving, by the infrastructure manager, the first performance information from the virtualization manager;
defining, by the infrastructure manager, a second performance threshold between the virtualization host and the virtualization manager; and
reconfiguring, by the infrastructure manager, the virtual desktop infrastructure when the first performance information exceeds the second performance threshold.
